(19) United States
(12) Patent Application Publication
(10) Pub. No.: US 2007/0132391 A1
(43) Pub. Date: Jun. 14, 2007

(54) Plasma display panel

(76) Inventors: Takashi Miyama, Yokohama-shi (JP); Yoshitaka Terao, Yokohama-shi (JP); Yukika Yamada, Yokohama-shi (JP)

Correspondence Address: Robert E. Bushnell, Suite 300, 1522 K Street, N.W., Washington, DC, 20005, US

(21) Appl. No.: 11/636,672

(22) Filed: Dec. 11, 2006

(30) Foreign Application Priority Data
Dec. 12, 2005 (JP) 2005-357631
Nov. 17, 2006 (KR) 10-2006-0113974

(51) Int. Cl. H01J 17/49

(52) U.S. Cl. 313/582

(57) ABSTRACT

A plasma display panel is constructed with sustain electrodes including a plurality of electrically conductive particles. The electrically conductive particles include ceramic particles and coating layers that coat the surface of the ceramic particles, and include at least one selected from the group consisting of metals, alloys, and mixtures thereof. The electrically conductive particles of the coating layers disposed to be adjacent each other are connected to each other to form a current path through the whole of each sustain electrode.

### CLAIM OF PRIORITY

This application makes reference to, incorporates the same herein, and claims all benefits accruing under 35 U.S.C. § 119 from applications for PLASMA DISPLAY PANEL earlier filed in the Japanese Patent Office on 12 Dec. 2005 and there duly assigned Serial No. 2005-357631, and for PLASMA DISPLAY PANEL earlier filed in the Korean Intellectual Property Office on 17 Nov. 2006 and there duly assigned Serial No. 10-2006-0113974.

### BACKGROUND OF THE INVENTION

1. Field of the Invention

The present invention relates to a plasma display panel. More particularly, the present invention relates to an alternating current (AC) plasma display panel including sustain electrodes facing each other that are inexpensive and have excellent shape precision properties.

2. Description of the Related Art

A plasma display panel (PDP) has a front substrate disposed on a side of a display surface that is directed toward viewers, and a rear substrate disposed opposite to the front substrate. The space between the front substrate and the rear substrate is a discharge space and is filled with a discharge gas, which is an inert gas, and is sealed. On the front substrate, which is a transparent substrate such as a glass substrate, X electrodes and Y electrodes are disposed to be extended in a horizontal direction of a screen. The X electrodes and the Y electrodes are collectively called sustain electrodes. Meanwhile, address electrodes extended in the vertical direction of the screen are disposed on the rear substrate, which is an insulation substrate such as a glass substrate. The rear substrate also includes a white dielectric layer to cover the address electrodes. On the white dielectric layer, barrier ribs are disposed in the shape of a lattice or stripes to partition the discharge space into a plurality discharge cells. The side surfaces of the barrier ribs and the surface of the white dielectric layer are coated with a phosphor layer. Discharge occurring between the X electrodes and the Y electrodes generates ultraviolet (UV) rays, which are radiated on the phosphor layer to emit visible light.

Contemporarily, the sustain electrodes are formed in the shape of a plane on a transparent substrate, and a transparent dielectric layer is disposed to cover the sustain electrodes. Recently, researchers have suggested counter-electrode PDPs that are constructed with sustain electrodes disposed opposite to each other to improve luminous efficiency. An example of the counter-electrode PDPs is disclosed in JP Laid-Open No. 2003-151449, specifically in FIGS. 6 and 7 of the reference.

A contemporary counter-electrode PDP is constructed with a front substrate and a rear substrate disposed opposite to each other, and a space between them which is filled with a discharge gas. Sustain electrodes are disposed in parallel to each other on a surface of the front substrate facing the rear substrate. Sustain electrodes may be formed by using diverse methods. For example, sustain electrodes may be formed by firing a silver paste. Thus, sustain electrodes may be made from a material containing silver (Ag) and an inorganic binder.

The contemporary counter-electrode PDP has the following drawbacks. The contemporary counter-electrode PDP has thick sustain electrodes, compared to a flat-electrode PDP where the sustain electrodes are formed in the form of a plane. This is to improve the luminous efficiency of the counter-electrode PDP. For instance, the counter-electrode PDP has sustain electrodes whose thickness ranges approximately from 50 μm to 150 μm, whereas the flat-electrode PDP has sustain electrodes that are typically thinner than 10 μm. Therefore, when the sustain electrodes are formed by firing a silver paste, the quantity of silver required for the fabrication of the sustain electrodes increases remarkably. Since silver is an expensive material, the production cost of the PDP increases as well. Also, there is a problem in that the silver paste shrinks by heat and the sustain electrodes are deformed because the gap between silver particles is reduced during the firing of the silver paste. The same problem occurs when the sustain electrodes are made from gold (Au) or platinum (Pt).

There have been attempts to use aluminum (Al) as a material for forming the sustain electrodes. Aluminum is cheaper and shrinks less than silver when it is exposed to heat during the firing. When aluminum wire is disposed in the entire PDP, however, there may be leak between the aluminum wire and the sealing frit for sealing the front substrate and the rear substrate. Also, when the sustain electrodes are made from aluminum and the wire contacting the sealing frit is made from silver, the connection part between the silver wire and the aluminum wire cracks due to a difference between the heat diffusion coefficients of silver and aluminum. Therefore, it is undesirable to form the sustain electrodes from aluminum.

### SUMMARY OF THE INVENTION

It is therefore an object of the present invention to provide an improved plasma display panel.

It is another object of the present invention to provide a plasma display panel constructed with sustain electrodes that are inexpensive and have excellent shape precision properties.

According to one embodiment of the present invention, a plasma display panel is provided with a first substrate, a second substrate facing the first substrate, and a discharge gas filling the space between the first and second substrates. The first substrate is constructed with an insulation substrate, a plurality of sustain electrodes disposed on the surface of the insulation substrate facing the second substrate, and a dielectric layer covering the sustain electrodes. The sustain electrodes are disposed facing each other, and each sustain electrode includes a plurality of electrically conductive particles. The electrically conductive particles include ceramic particles, and coating layers that coat the surface of the ceramic particles and that include at least one selected from the group consisting of metals, alloys, and mixtures thereof. The coating layers of the electrically conductive particles are disposed to be adjacent to each other and are electrically connected to each other to form a current path through the whole sustain electrode.

According to another embodiment of the present invention, a plasma display panel is provided with a first substrate, a second substrate facing the first substrate, and a discharge gas filled between the first and second substrates. The first substrate is constructed with an insulation substrate, a plurality of sustain electrodes disposed on the surface of the insulation substrate facing the second substrate, and a dielectric layer covering the sustain electrodes. The sustain electrodes are disposed facing each other, and each sustain electrode includes a plurality of electrically conductive particles and metal particles. The electrically conductive particles include ceramic particles, and coating layers that coat the surface of the ceramic particles and that include at least one selected from the group consisting of metals, alloys, and mixtures thereof. The metal particles are at least one selected from the group consisting of silver, gold, nickel, copper, platinum, silver-palladium alloys, and combinations thereof. The coating layers of electrically conductive particles and metal particles are disposed to be adjacent to each other and are electrically connected to each other to form a current path through the whole sustain electrode.

According to the embodiments of the present invention, the plasma display panel is provided with an X electrode and a Y electrode facing each other, and discharge is performed between the two electrodes resulting in a low discharge firing voltage and high luminous efficiency. Since each sustain electrode includes electrically conductive particles including ceramic particles therein, metals or alloy for maintaining electrical conductivity of the sustain electrode exist only in the electrically conductive particle coating layer. Thereby, small amounts of metals or alloys are sufficient for electrical conductivity of the sustain electrode with respect to the thickness of the sustain electrode, which can reduce the cost of a plasma display panel. When the electrically conductive particles are fired, the coating layers of adjacent electrically conductive particles are assembled with each other to form a current path. On the other hand, the ceramic particles are not deformed during the firing and thereby electrode heat-shrinkage can be suppressed, which results in a high shape precision of the sustain electrode.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view showing a contemporary counter-electrode plasma display panel (PDP);

FIG. 2 is a cross-sectional view describing a PDP constructed as an embodiment of the principles of the present invention;

FIG. 3 is a cross-sectional view illustrating an electrically conductive particle constructed as an embodiment of the principles of the present invention;

FIG. 4 is a cross-sectional view describing an X electrode of the plasma display panel shown in FIG. 2; and

FIG. 5A is a cross-sectional view showing an address electrode after firing in a plasma display panel as an embodiment of the present invention, and FIG. 5B is a cross-sectional view showing an address electrode after firing in a contemporary plasma display panel.

### DETAILED DESCRIPTION OF THE INVENTION

An exemplary embodiment of the present invention will hereinafter be described in detail with reference to the accompanying drawings.

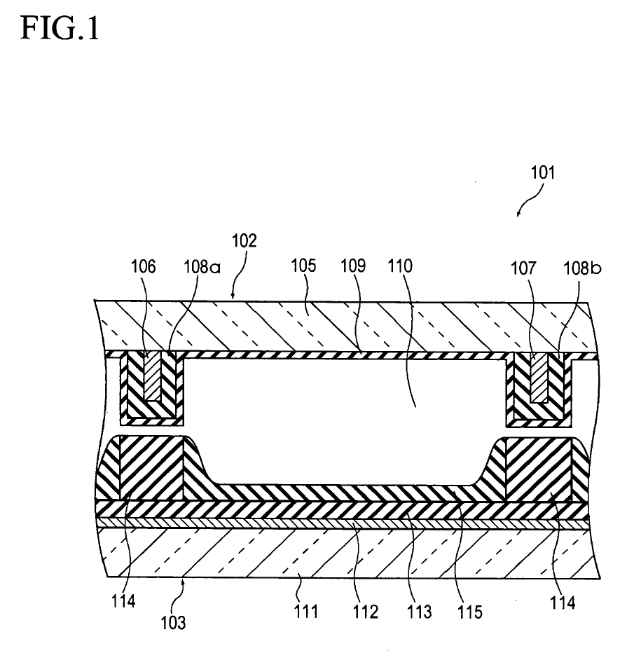

FIG. 1 is a partial cross-sectional view showing a contemporary counter-electrode PDP.

In contemporary PDP 101, a front substrate 102 and a rear substrate 103 are disposed opposite to each other, and a space between them, which is a discharge space, is filled with a discharge gas and is sealed.

Front substrate 102 is constructed with a glass substrate 105. X electrodes 106 and Y electrodes 107 that are sustain electrodes, are disposed alternately and in parallel to each other on a surface of glass substrate 105 facing rear substrate 103. X electrodes 106 and Y electrodes 107 may be formed using diverse methods. For example, X electrodes 106 and Y electrodes 107 may be formed by firing a silver paste. Thus, they may be made from a material containing silver (Ag) and an inorganic binder. X electrodes 106 and Y electrodes 107 are covered by a dielectric layer 108.

Also, a bridge (not shown) made from a dielectric material is disposed between dielectric layer 108a covering X electrodes 106 and dielectric layer 108b covering Y electrodes 107. Barrier ribs (not shown) are formed in the shape of a lattice defined by X electrodes 106, Y electrodes 107, and dielectric layer 108. The barrier ribs partition the discharge space into a plurality of discharge cells 110. In addition, a protective layer 109 made from magnesium oxide (MgO) covers glass substrate 105 and the barrier ribs. Protective layer 109 is the only structure disposed within discharge cells 110 and between dielectric layer 108a covering X electrodes 106 and dielectric layer 108a covering Y electrodes 107. Discharge cells 110 further include a discharge path (not shown) for a discharge gas.

Meanwhile, rear substrate 103 is constructed with a glass substrate 111 and address electrodes 112 disposed on a surface of glass substrate 111 facing front substrate 102. Address electrodes 112 are extended in a direction traversing X electrodes 106 and Y electrodes 107. Address electrodes 112 are covered with a white dielectric layer 113 on glass substrate 111. Lattice-shaped barrier ribs 114 are formed on white dielectric layer 113. Barrier ribs 114 are disposed at a position facing the barrier ribs formed on front substrate 102. The side surfaces of barrier ribs 114 and the surface of white dielectric layer 113 facing front substrate 2 are coated with a phosphor layer 115.

In contemporary PDP 101 formed as described above, discharge occurs in the discharge space filled with the discharge gas between dielectric layer 108a covering X electrodes 106 and dielectric layer 108b covering Y electrodes 107 by applying a voltage between X electrodes 106 and Y electrodes 107. The discharge produces ultraviolet (UV) rays. When the ultraviolet rays are radiated to phosphor layer 115, phosphor layer 115 emits visible light. The visible light is transmitted through glass substrate 105 of front substrate 102, and is emitted from a display surface of PDP 101. An image may be visually displayed on the entire display surface of PDP 101 by controlling the number of occurrences of discharge in each discharge cell 110 within one field that displays one image.

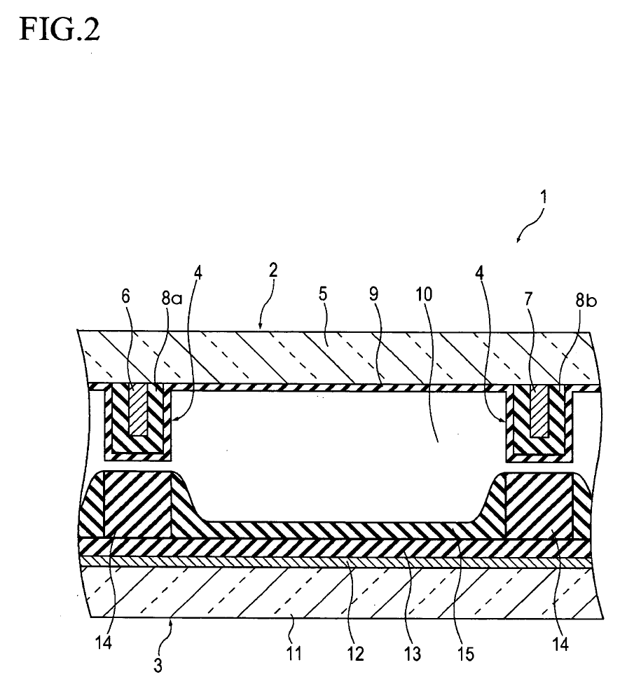

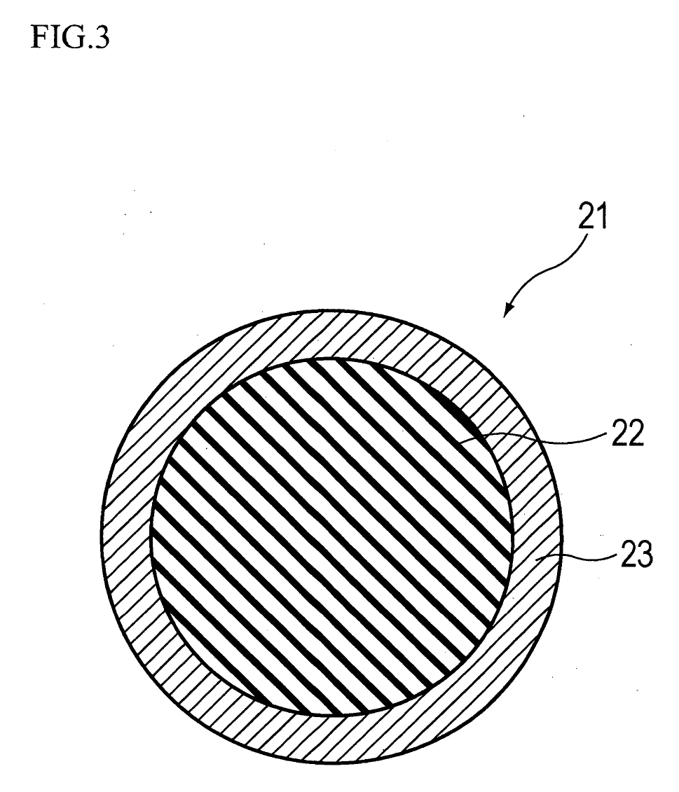

FIG. 2 is a cross-sectional view showing a plasma display panel (PDP) constructed as an embodiment of the principles of the present invention.

PDP 1 includes a front substrate 2 and a rear substrate 3 facing each other and disposed in parallel to each other. The space between front substrate 2 and rear substrate 3 is filled with a discharge gas. The discharge gas may be an inert gas, specifically a Ne—Xe mixed gas including 7 to 15 vol % xenon (Xe), and neon (Ne) as a balance. PDP 1 is an alternating-current (AC) PDP.

Front substrate 2 is constructed with an insulation substrate, which is a transparent glass substrate 5 though which visible light can be transmitted. On the surface of glass substrate 5 facing rear substrate 3, X electrodes 6 and Y electrodes 7 are alternately disposed in parallel to each other. X electrodes 6 and Y electrodes 7 may be collectively called sustain electrodes. X electrodes 6 and Y electrodes 7 face each other. The direction that the sustain electrodes are extended may be a horizontal direction of a screen of PDP 1. Also, front substrate 2 includes dielectric layers 8a and 8b that respectively covers X electrodes 6 and Y electrodes 7. Dielectric layers 8a and 8b may be made from glass having a low melting point, such as lead glass.

Also, a bridge (not shown) is disposed between dielectric layer 8a covering X electrodes 6 and dielectric layer 8b covering Y electrodes 7. The bridge is extended in a direction crossing the direction that both X electrode 6 and Y electrodes 7 are extended, for example, in the vertical direction of the screen of PDP 1. The bridge, X electrodes 6, Y electrodes 7 and dielectric layers 8a and 8b form lattice-shaped first barrier ribs 4. The bridge is made from the same material as dielectric layers 8a and 8b, which is glass having a low melting point, such as lead glass. First barrier ribs 4 partition the space between front substrate 2 and rear substrate 3 into a plurality of discharge cells 10.

In addition, a protective layer 9 made from magnesium oxide (MgO) covers glass substrate 5 and first barrier ribs 4. Protective layer 9 prevents glass substrate 5 and first barrier ribs 4 from being sputtered by discharge, and supplies secondary electrons to discharge cells 10.

Meanwhile, rear substrate 3 is constructed with a glass substrate 11 as an insulation substrate, and address electrodes 12 disposed on a surface of glass substrate 11 facing front substrate 2. Address electrodes 12 are extended in a direction traversing the direction that X electrodes 6 and Y electrodes 7 are extended, which may be a vertical direction of the screen. Each address electrode 12 passes through the central part of each discharge cell 10, when rear substrate 3 is seen from front substrate 2.

Rear substrate 3 is also constructed with a white dielectric layer 13 covering address electrodes 12 disposed on top of glass substrate 11. In addition, lattice-shaped second barrier ribs 14 are disposed on white dielectric layer 13. Second barrier ribs 14 are disposed in a position corresponding to first barrier ribs 4 on front substrate 2. The side surfaces of second barrier ribs 14 and the surface of white dielectric layer 13 are coated with a phosphor layer 15. Phosphor layer 15 emits visible light of any one color among red (R), green (G), and blue (B), when ultraviolet (UV) rays are radiated.

Hereinafter, the constituent elements of PDP 1 will be presented with specific exemplary sizes. The present invention, however, is not limited to the sizes. The length of a line connecting adjacent X and Y electrodes 6 and 7 may be approximately 700 μm, and the length of a line connecting adjacent bridges may be approximately 300 μm. Also, the height of X electrodes 6 and Y electrodes 7 may be approximately 50 μm to 400 μm, and the height of the barrier ribs, i.e., the combined height of dielectric layer 8a and X electrodes 6, or the combined height of dielectric layer 8b and Y electrodes 7, may be approximately 100 μm to 500 μm. The widths of X electrodes 6 and Y electrodes 7 may range from approximately 100 μm to approximately 250 μm. Also, the thickness of white dielectric layer 13 may range from approximately 20 μm to approximately 30 μm. The thickness of address electrodes 12 may be approximately 5 μm.

X electrodes 6, Y electrodes 7, and address electrodes 12, which will be referred to as “the electrodes” collectively, each include electrically conductive particles formed through firing.

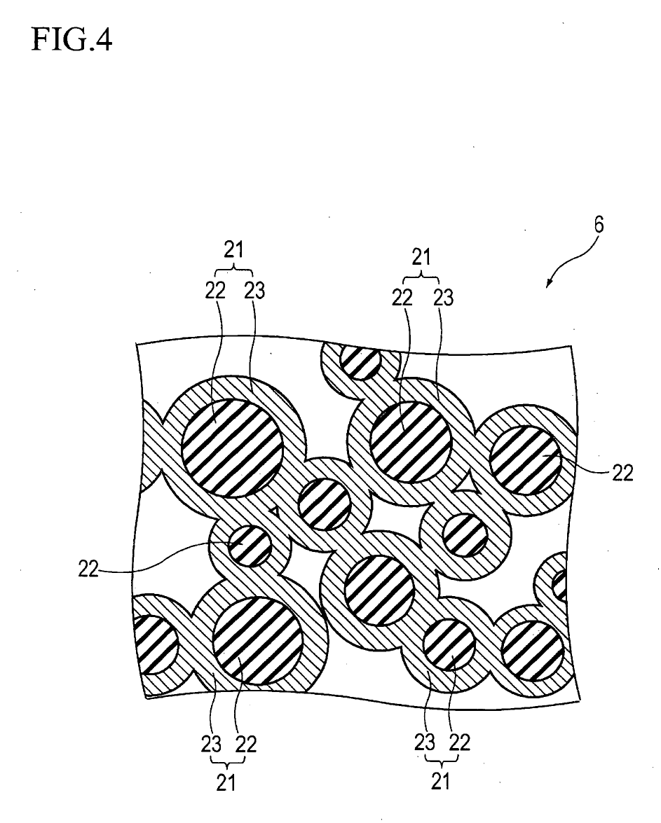

FIG. 3 is a cross-sectional view showing an electrically conductive particle of the electrodes, and FIG. 4 is a cross-sectional view enlarging the X electrode, which includes electrically conductive particles, of the plasma display panel shown in FIG. 2.

As shown in FIG. 3, electrically conductive particles 21 that form the electrodes of PDP 1 include a ceramic material, which is a mother particle 22 containing silicon oxide (SiO₂), and a coating layer 23 coating mother particle 22. Coating layer 23 is made from metal, an alloy, or a combination of metal and an alloy. Mother particle 22 may have a spherical shape having a diameter of approximately 1.5 μm. Also, the thickness of coating layer 23 may range from approximately 50 nm to approximately 150 nm.

Mother particle 22 may be made from a ceramic material other than silicon oxide. Mother particle 22 can be made from aluminum oxide (Al₂O₃), zirconium oxide (ZrO₂), titanium oxide (TiO₂), or a combination thereof. Coating layer 23 can be made from another metal or alloy other than silver. For example, coating layer 23 can be made from silver (Ag), gold (Au), nickel (Ni), copper (Cu), platinum (Pt), a silver-palladium (Ag—Pd) alloy, or a combination thereof.

As illustrated in FIG. 4, coating layers 23 of adjacent electrically conductive particles 21 coalesce with each other in X electrode 6. Thus, electrically conductive particles 21 are sintered to each other. Also, the coalescing among coating layers 23 forms a current path throughout the entire electrodes. The same occurs in Y electrodes 7 and address electrodes 12.

A method for preparing a PDP 1 according to an embodiment of the present invention will be described hereinafter.

First, a method for preparing electrically conductive particles 21 will be described.

A powder material including silicon oxide having a diameter of approximately 1.5 μm is prepared. The powder material is used as mother particle 22. A silver layer having a thickness of 50 nm to 150 nm, which is coating layer 23, is formed by educing silver through electroless plating on the surface of mother particle 22. In this way, electrically conductive particles 21 are prepared.

Coating layer 23 may be formed by using a method other than the electroless plating. For example, it may be formed in a mechano-chemical method or a solution reduction method. According to the mechano-chemical method, the surface of the silicon oxide powder may be mechanically coated with silver powder by putting silicon oxide powder and silver powder having a smaller diameter than the silicon oxide powder into a cylindrical container, sealing the cylindrical container, and rotating a rotor in the cylindrical container at a high speed.

Subsequently, an organic vehicle is prepared by dissolving ethyl cellulose resin in terpineol. The organic vehicle is mixed with electrically conductive particles 21 to thereby prepare an electrically conductive paste. Meanwhile, the organic vehicle functions as a binder among the electrically conductive particles.

Glass frit may be added to the electrically conductive paste as an inorganic binder.

Hereinafter, a method for preparing front substrate 2 will be described.

As shown in FIG. 2, glass substrate 5 is prepared first. Glass substrate 5 is coated with a silver paste, and is dried and fired to thereby form a silver extraction electrode (not shown). Subsequently, the upper surface of glass substrate 5 is coated with a dielectric material paste by using a coating apparatus, which is dried to thereby form a barrier rib material layer (not shown). The dielectric material paste may be a paste containing a solvent and glass having a low melting point.

Subsequently, a dry film resist (DFR) is laminated onto the barrier rib material layer with a laminator. The DFR is exposed to light and developed to thereby form openings in areas where X electrodes 6, Y electrodes 7, and discharge cells 10 are to be formed. Subsequently, sandblasting is performed by using the DFR as a mask to selectively remove the barrier rib material layer disposed below the opening of the DFR. Accordingly, the discharge cells 10 are formed, and at the same time, a groove extended in one direction is formed on the barrier rib material layer. Subsequently, the DFR is exfoliated.

The groove of the barrier rib material layer is filled with an electrically conductive paste including the aforementioned electrically conductive particles 21 through screen printing or a dispenser method. Subsequently, the entire surface is coated with the dielectric material paste through a coating method, and the dielectric material paste is dried.

Glass substrate 5 and the structures formed thereon are heated at a temperature at which the dielectric material paste and the electrically conductive paste are sintered and glass substrate 5 is not softened, specifically at a temperature ranging from approximately 520° C. to 600° C., more specifically at 550° C. The electrically conductive paste is sintered to become X electrodes 6 and Y electrodes 7, while the barrier rib material layer and the dielectric material paste are sintered to become dielectric layer 8 and the bridges, and first barrier ribs 4 are thereby formed. Herein, X electrodes 6 and Y electrodes 7 are connected to the silver extraction electrode. Subsequently, magnesium oxide (MgO) is disposed to cover glass substrate 5 and first barrier rib 4 to form protective layer 9. In this way, the fabrication of front substrate 2 is completed.

Herein, coating layers 23 of the adjacent electrically conductive particles 21 coalesce with each other in X electrodes 6 and Y electrodes 7 to form a current path throughout the entire electrodes. Since mother particle 22 is rarely deformed before and after the firing, the gap between the electrically conductive particles 21 is not reduced and the heat shrinkage amount following the firing is small.

Meanwhile, rear substrate 3 is fabricated.

First, glass substrate 11 is prepared. Address electrodes 12 are disposed on top of glass substrate 11 in the same method with which X electrodes 6 and Y electrodes 7 of front substrate 2 are formed. To describe the method, the electrically conductive paste including electrically conductive particles 21 is fired to form address electrodes 12. Subsequently, white dielectric layer 13 is disposed to cover address electrodes 12 on the entire surface of glass substrate 11.

Subsequently, the upper surface of white dielectric layer 13 is coated with the dielectric material paste, which is then dried, and patterned to form second barrier ribs 14. Then, the upper surface of white dielectric layer 13 and the sides of second barrier ribs 14 are coated with a phosphor paste in a method such as screen printing, and they are dried and fired to form phosphor layer 15.

Subsequently, sealing frit is disposed to cover the area where first barrier ribs 4 and second barrier ribs 14 are formed on the surface of front substrate 2 and rear substrate 3, respectively. Then, front substrate 2 is overlapped with rear substrate 3. First barrier ribs 4 are precisely engaged with second barrier ribs 14 and, simultaneously, the direction that X electrodes 6 and Y electrodes 7 are extended is traversed with the direction that address electrodes 12 are extended. Herein, each address electrode 12 passes through the center of each discharge cell 10 partitioned by first barrier ribs 4 and second barrier ribs 14. Subsequently, the sealing frit is fired at a temperature of about 450° C. Subsequently, the air in the space surrounded by front substrate 2, rear substrate 3, and the sealing frit is exhausted, and a discharge gas is injected into the space. In this way, PDP 1 is prepared.

Hereinafter, the operation of the PDP will be described according to the embodiment of the present invention.

PDP 1 divides one field that displays one image into a plurality of subfields and sets up an initialization period, an addressing period, and a sustain period for each subfield. During the initialization period, all discharge cells 10 are forced to perform discharge to thereby initialize the distribution of charges in discharge cells 10. Then, during the addressing period, X electrodes 6 or Y electrodes 7 are scanned while optionally applying a voltage to address electrodes 12. Address discharge occurs in a discharge cell 10 that is desired to emit light in the corresponding subfield to thereby form wall charges.

Subsequently, when an alternating (AC) voltage is applied to the space between X electrodes 6 and Y electrodes 7 in the sustain period, the alternating voltage is applied across discharge cells 10 where wall charges are formed and thus sustain discharge occurs by the discharge gas between dielectric layer 8a covering X electrodes 6 and dielectric layer 8b covering Y electrodes 7. The sustain discharge generates ultraviolet (UV) rays, which may have a wavelength of about 147 nm. When the ultraviolet rays are radiated onto phosphor layer 15, phosphor layer 15 emits visible light. The visible light transmits through the glass substrate 5 of front substrate 2 and is emitted from the display surface of PDP 1.

Grayscales can be expressed by differentiating the number of occurrences of sustain discharge between the multiple subfields of one field and selecting a combination of subfields that emit light for each discharge cell 10. Accordingly, an image can be shown in the entire display surface of PDP 1.

Hereinafter, the effect of a PDP fabricated according to the embodiment of the present invention will be described.

According to the embodiment of the present invention, X electrodes 6, Y electrodes 7 and address electrodes 12 of PDP 1 are fabricated by firing the electrically conductive particles 21. Electrically conductive particles 21 are formed by coating the surface of mother particle 22 including silicon oxide with a silver coating layer 23. Thus, when the electrically conductive particles 21 contact each other, their coating layers 23 necessarily contact each other. For this reason, when the electrically conductive particles 21 go through the firing process, coating layers 23 of adjacent electrically conductive particles 21 are connected to each other to thereby form a current path.

Since the greatest proportion, with respect to volume, of electrically conductive particles 21 is occupied by mother particle 22, it is possible to reduce the quantity of silver used, compared to a case when the electrodes are fabricated by firing a silver paste containing silver particles. Consequently, the material cost for fabricating PDP 1 can be reduced. Particularly, the counter-electrode PDP 1 has larger X electrodes and Y electrodes than a PDP using flat electrodes. Thus, the method of the embodiment that decreases the used quantity of silver makes a considerable contribution to the reduction of production cost. For example, when electrically conductive particles having a 150 nm-thick coating layer 23 is used, the quantity of silver used can be reduced to a tenth of that used in a case where silver particles are used.

Also, since mother particle 22 is hardly deformed during the firing, it is possible to suppress the heat shrinkage of the electrically conductive paste containing electrically conductive particles 21. This property prevents the shapes of X electrodes 6 and Y electrodes 7 from being destroyed by the firing. Accordingly, the sustain electrodes maintain fine shape precision and discharge characteristics.

Also, since address electrodes 12 are formed by firing the electrically conductive particles 21, it is possible to prevent address electrode 12 from edge curling. This effect will be described with reference to the accompanying drawings.

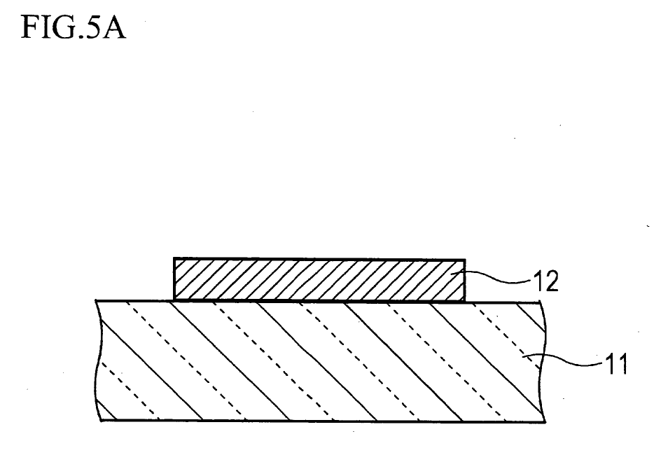

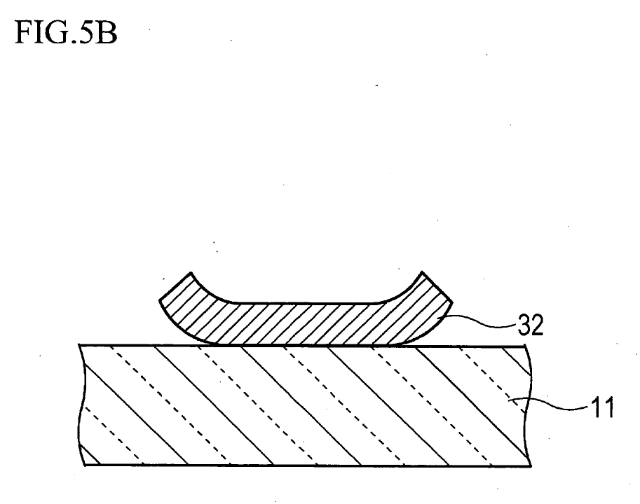

FIG. 5A is a cross-sectional view showing an address electrode after firing in the PDP prepared according to an embodiment of the present invention, and FIG. 5B is a cross-sectional view showing an address electrode of a contemporary PDP.

In the PDP prepared according to the embodiment of the present invention, which is shown in FIG. 5A, address electrodes 12 are formed by applying the electrically conductive paste containing electrically conductive particles 21 on glass substrate 11 and firing glass substrate 11 coated with the electrically conductive paste. The electrically conductive paste shrinks during the firing. However, since the electrically conductive paste used in the PDP of the present embodiment has a low heat shrinkage ratio, address electrodes 12 are hardly deformed after the firing.

Meanwhile, a contemporary PDP will be described as a comparative example. Address electrodes 32 of the contemporary PDP are fabricated by applying a silver paste including silver particles onto glass substrate 11 and firing them. In this case, the silver paste shrinks a lot by the firing. Since the lower surface of the silver paste is attached to glass substrate 11 and the upper surface is exposed, the edge of address electrodes 32 is deformed such that the silver paste comes off from glass substrate 1, which is called “edge curling.” This property of edge curling deteriorates the shape precision of the address electrodes and makes the discharge characteristics unstable.

To sum up, the method of the present invention can provide address electrodes with fine shape precision.

As described above, the method of the present invention can prepare a counter-electrode PDP with a small quantity of silver, because the electrically conductive particles are prepared by coating the surface of the mother particle containing silicon oxide with a coating layer containing silver, and the sustain electrodes and the address electrodes are fabricated by firing the electrically conductive particles. Therefore, a PDP with high shape precision can be produced at a low material cost.

Although both the sustain electrodes and the address electrodes are fabricated by using the electrically conductive particles in the embodiments of the present invention, the present invention is not limited to this. Since the address electrodes are smaller than the sustain electrodes with respect to volume, fabricating the sustain electrodes by using the electrically conductive particles 21 can reduce the production cost of the PDP more than fabricating the address electrodes by using the electrically conductive particles 21. Also, the deformation quantity of the address electrodes caused by the heat shrinkage is smaller than that of the sustain electrodes. Therefore, the address electrodes may be fabricated by firing the silver paste containing silver particles, just as in the contemporary method. Accordingly, the rear substrate may be fabricated by using a contemporary method.

The electrically conductive paste for the sustain electrodes may further contains metal particles in addition to electrically conductive particles 21 and binders. The metal particles may be at least one selected from the group consisting of silver, gold, nickel, copper, platinum, silver-palladium alloys, and combinations thereof. The electrically conductive particles and metal particles are connected to each other during firing to form a current path through a whole sustain electrode. Electrical conductivity can be improved by adding metal particles to an electrically conductive paste containing the electrically conductive particles.

The following examples illustrate the present invention in more detail. However, it is understood that the present invention is not limited by these examples.

### EXAMPLE 1

Electrically conductive particles were prepared by coating mother particles containing silicon oxide (SiO₂) and having an average diameter of 1.5 μm with a coating layer containing silver (Ag). The thickness of the coating layer was about 50 nm.

### EXAMPLE 2

Electrically conductive particles were prepared by coating mother particles containing silicon oxide (SiO₂) and having an average diameter of 1.5 μm with a coating layer containing silver (Ag). The thickness of the coating layer was about 150 nm.

### COMPARATIVE EXAMPLE 1

Electrically conductive particles were prepared by using silver particles having an average diameter of 1.5 μm.

The influence of the kind of the electrically conductive particles on the heat shrinkage in Examples 1 and 2 and Comparative Example 1 was examined.

The electrically conductive particles of Examples 1 and 2 and Comparative Example 1 were mixed with resin and glass frit to form a paste. The content of the glass frits was 5 mass % of the electrically conductive particles. Meanwhile, the glass frit was added to the silver paste of Comparative Example 1 including silver particles in the same content. The above-prepared pastes were applied to the entire surface of glass substrates at a thickness of 50 μm, individually. The pastes on the glass substrates were fired at a temperature of about 550° C. After the firing, the thicknesses of the layers formed from the pastes were measured, and the shrinkage ratios and film maintenance ratios were calculated. The results are shown in Table 1.

In the following Table 1, “SiO₂+Ag of particle” means a mother particle made from silicon oxide (SiO₂) coated with a coating layer containing silver, and “Ag” means a powder of a silver elementary substance. Also, “coating layer (nm)” signifies the thickness of the coating layer.

Also, the shrinkage ratio and the film maintenance ratio were calculated as follows.
Shrinkage ratio (%)={(film thickness before firing)−(film thickness after firing)}/(film thickness before firing)×100
Film maintenance ratio (%)=(film thickness after firing)/(film thickness before firing)×100

TABLE 1

| | | | | Film |
|---|---|---|---|---|
| | | Coating layer | Shrinkage | maintenance |
| | Particle | (nm) | ratio(%) | ratio(%) |
| Example 1 | SiO₂ + Ag | 50 | 0.9 | 99.1 |
| Example 2 | SiO₂ + Ag | 150 | 3.1 | 96.9 |
| Comparative | Ag | — | 40 | 60 |
| Example 1 | | | | |

As shown in Table 1, Examples 1 and 2 of the present invention showed low shrinkage ratios, because the electrically conductive particles made from the mother particle including silicon oxide coated with a silver coating layer were fired. On the contrary, Comparative Example 1 showed a high shrinkage ratio because the silver particles were fired. Thus, the PDP electrodes fabricated by using the electrically conductive particles of Examples 1 and 2 were less deformed by the heat shrinkage and had better shape precision than the electrodes fabricated by using the silver particles of Comparative Example 1.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

For example, although those skilled in the art may modify the shapes of the electrodes, the barrier ribs, the dielectric layer, and the phosphor layer, as well as the driving method, the modified results belong to the scope of the present invention as long as they possess the features of the present invention. For example, second barrier ribs 14 of FIG. 1 may be omitted and phosphor layer 15 may be formed protruded toward front substrate 2 in discharge cells 10.

According to one embodiment of the present invention, small amounts of metals or alloys are sufficient for providing electrical conductivity of sustain electrodes, and heat-shrinkage of sustain electrodes is suppressed during the firing, which can provide a plasma display panel having high shape precision of sustain electrodes at a low cost.

What is claimed is:

1. A plasma display panel, comprising:
a first substrate;
a second substrate facing the first substrate; and
a discharge gas filled between the first and second substrates,
with the first substrate comprising:
an insulation substrate,
a plurality of sustain electrodes disposed on the surface of the insulation substrate facing the second substrate, and
a dielectric layer covering the sustain electrodes,
with the sustain electrodes being disposed facing each other and each sustain electrode comprising a plurality of electrically conductive particles,
with the electrically conductive particles comprising ceramic particles and coating layers that coat the surface of the ceramic particles and that comprise at least one selected from the group consisting of metals, alloys, and mixtures thereof, and
with the coating layers of the electrically conductive particles being disposed to be adjacent to each other and being electrically connected to each other to form a current path through the whole sustain electrode.

2. The plasma display panel of claim 1, with the ceramic particles being at least one selected from the group consisting of silicon oxide, aluminum oxide, zirconium oxide, titanium oxide, and combinations thereof.

3. The plasma display panel of claim 1, with the coating layer comprising at least one selected from the group consisting of silver, gold, nickel, copper, platinum, a silver-palladium alloy, and combinations thereof.

4. The plasma display panel of claim 1, with the second substrate comprising:
an insulation substrate; and
address electrodes disposed on a surface facing the first substrate in a crossing direction with the sustain electrodes,
with each address electrode comprising a plurality of electrically conductive particles,
with the electrically conductive particles comprising ceramic particles and coating layers that coat the surface of the ceramic particles and that comprise at least one selected from the group consisting of metals, alloys, and mixtures thereof, and
with the coating layers of the electrically conductive particles being disposed to be adjacent to each other and being electrically connected to each other to form a current path through the whole address electrode.

5. The plasma display panel of claim 4, with the ceramic particles being at least one selected from the group consisting of silicon oxide, aluminum oxide, zirconium oxide, titanium oxide, and combinations thereof.

6. The plasma display panel of claim 4, with the coating layer comprising at least one selected from the group consisting of silver, gold, nickel, copper, platinum, a silver-palladium alloy, and combinations thereof.

7. A plasma display panel, comprising:
a first substrate;
a second substrate facing the first substrate; and
a discharge gas filled between the first and second substrates,
with the first substrate comprising:
an insulation substrate,
a plurality of sustain electrodes disposed on the surface of the insulation substrate facing the second substrate, and
a dielectric layer covering the sustain electrodes,
with the sustain electrodes being disposed facing each other and each sustain electrode comprising a plurality of electrically conductive particles and metal particles,
with the electrically conductive particles comprising ceramic particles and coating layers that coat the surface of the ceramic particles and that comprise at least one selected from the group consisting of metals, alloys, and mixtures thereof,
with the metal particles being at least one selected from the group consisting of silver, gold, nickel, copper, platinum, silver-palladium alloys, and combinations thereof, and
with the coating layers of electrically conductive particles and metal particles being disposed to be adjacent to each other and being electrically connected to each other to form a current path through the whole sustain electrode.

8. The plasma display panel of claim 7, with the ceramic particles being at least one selected from the group consisting of silicon oxide, aluminum oxide, zirconium oxide, titanium oxide, and combinations thereof.

9. The plasma display panel of claim 7, with the coating layer comprising at least one selected from the group consisting of silver, gold, nickel, copper, platinum, a silver-palladium alloy, and combinations thereof.

10. The plasma display panel of claim 7, with the second substrate comprising:
an insulation substrate; and
address electrodes disposed on a surface facing the first substrate in a crossing direction with the sustain electrodes,
with each address electrode comprising a plurality of electrically conductive particles,
with the electrically conductive particles comprising ceramic particles and coating layers that coat the surface of the ceramic particles and that comprise at least one selected from the group consisting of metals, alloys, and mixtures thereof, and
with the coating layers of the electrically conductive particles being disposed to be adjacent to each other and being electrically connected to each other to form a current path through the whole of each address electrode.

11. The plasma display panel of claim 10, with the ceramic particles being at least one selected from the group consisting of silicon oxide, aluminum oxide, zirconium oxide, titanium oxide, and combinations thereof.

12. The plasma display panel of claim 10, with the coating layer comprising at least one selected from the group consisting of silver, gold, nickel, copper, platinum, a silver-palladium alloy, and combinations thereof.

13. A method for fabricating electrodes in a plasma display panel, the method comprising the steps of:
preparing a plurality of electrically conductive particles, each electrically conductive particle containing a ceramic particle coated of an electrically conductive coating layer;
preparing an electrically conductive paste containing the electrically conductive particles;
coating a dielectric material paste onto a substrate of the plasma display panel;
forming grooves in the layer of dielectric material paste;
filling the grooves in the layer of dielectric material paste with the electrically conductive paste; and
heating the substrate with the dielectric material paste and the electrically conductive paste to coalesce the electrically conductive coating layers of the electrically conductive particle, forming an electrically conductive current path.

14. The method of claim 13, with the ceramic particles being at least one selected from the group consisting of silicon oxide, aluminum oxide, zirconium oxide, titanium oxide, and combinations thereof.

15. The method of claim 13, with the coating layer comprising at least one selected from the group consisting of silver, gold, nickel, copper, platinum, a silver-palladium alloy, and combinations thereof.

16. The method of claim 13, with the step of preparing the plurality of electrically conductive particles comprising the step of the coating the ceramic particles with the electrically conductive coating layer by electroless plating.

17. The method of claim 13, with the step of preparing the electrically conductive paste further comprising:
preparing an organic vehicle by dissolving ethyl cellulose resin in terpineol; and
mixing the organic vehicle with the electrically conductive paste.

18. The method of claim 13, with the step of forming grooves in the layer of dielectric material paste further comprising:
laminating a dry film resist onto the layer of dielectric material paste;
patterning the dry film resist to form openings;
selectively removing the dielectric material in the openings; and
exfoliating the dry film resist.

19. The method of claim 13, with the step of filling the grooves in the layer of dielectric material paste with the electrically conductive paste being performed by screen printing or a dispenser method.
